(19) United States
(12) Patent Application Publication
(10) Pub. No.: US 2025/0265023 A1
(43) Pub. Date: Aug. 21, 2025

(54) PRINTING SYSTEM, PRINTING APPARATUS, AND METHOD OF CHANGING SETTING OF PRINTING SYSTEM

(71) Applicant: SEIKO EPSON CORPORATION, Tokyo (JP)

(72) Inventor: Yukari TAKIGUCHI, SHIOJIRI-SHI (JP)

(21) Appl. No.: 19/058,603

(22) Filed: Feb. 20, 2025

(30) Foreign Application Priority Data
Feb. 21, 2024 (JP) 2024-024355

(51) Int. Cl. G06F 3/12

(52) U.S. Cl. CPC G06F 3/1238; G06F 3/1222; G06F 3/1231

(57) ABSTRACT

A printing system includes a printing apparatus including a first radio communication unit configured to perform Peer-to-Peer communication, a network communication unit, a printing unit, a storage unit configured to store a setting of the printing apparatus, and a first control unit configured to cause the printing unit to print a special code, and an information processing apparatus including a second radio communication unit configured to perform P2P communication, a reading unit configured to read the special code, and a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

The present application is based on, and claims priority from JP Application Serial Number 2024-024355, filed Feb. 21, 2024, the disclosure of which is hereby incorporated by reference herein in its entirety.

### BACKGROUND

### 1. Technical Field

The present disclosure relates to a printing system, a printing apparatus, an information processing apparatus, and a method of changing the setting of the printing system.

### 2. Related Art

In the related art, a printing system is known that performs various settings of printing apparatuses using an information processing apparatus such as a smartphone.

For example, WO2014/106882 discloses a device control system that allows for viewing and modifying web service settings of a printing apparatus via a web application running on a web browser.

However, in order to connect an information processing apparatus and a printing apparatus by means of a web application and to change web service settings of the printing apparatus, the user has been required to operate and start the web application and connect the information processing apparatus and the printing apparatus. This has placed a burden on the user.

### SUMMARY

A printing system of the present disclosure includes a printing apparatus, and an information processing apparatus, in which the printing apparatus includes a first radio communication unit configured to perform Peer-to-Peer communication, a network communication unit configured to perform network communication, a printing unit configured to print an image on a medium, a storage unit configured to store a setting of the printing apparatus, and a first control unit configured to cause the printing unit to print a special code including address information for the network communication when the first radio communication unit is in an enabled state and the printing apparatus is activated in a state where a condition set in advance is met, and the information processing apparatus includes a second radio communication unit configured to perform P2P communication, a reading unit configured to read the special code, and a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

A printing apparatus of the present disclosure includes a first radio communication unit configured to perform Peer-to-Peer communication, a network communication unit configured to perform network communication, a printing unit configured to print an image on a medium, a storage unit configured to store a setting of the printing apparatus, and a first control unit configured to cause the printing unit to print a special code including address information for the network communication when the first radio communication unit is in an enabled state and the printing apparatus is activated in a state where a condition set in advance is met.

An information processing apparatus of the present disclosure includes a second radio communication unit configured to perform the P2P communication, a reading unit configured to read the special code, a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

In a method of changing a setting of a printing system of the present disclosure, the printing system including a printing apparatus and an information processing apparatus, the printing apparatus including a first radio communication unit configured to perform Peer-to-Peer communication, a network communication unit configured to perform network communication, and a printing unit configured to print an image on a medium, the information processing apparatus including a second radio communication unit configured to perform the P2P communication, and a reading unit, in which the printing apparatus causes the printing unit to print a special code including address information for the network communication when the first radio communication unit is in an enabled state and the printing apparatus is activated in a state where a condition set in advance is met, and the information processing apparatus accesses the printing apparatus based on the special code read by the reading unit, causes a display device to display an operation screen for receiving a change to the setting of the printing apparatus, and sends, to the printing apparatus, a changed setting of the printing apparatus when an operation of changing the setting of the printing apparatus is received.

### BRIEF DESCRIPTION OF THE DRAWINGS

FIG. 1 is a diagram illustrating a system configuration of a printing system.

FIG. 2 is a diagram illustrating an example of an APP screen.

FIG. 3 is a flowchart of an operation of a printing apparatus.

FIG. 4 is a flowchart of an operation of an information processing apparatus.

### DESCRIPTION OF EMBODIMENTS

An embodiment of the present disclosure is described below with reference to the accompanying drawings.

### 1. System Configuration of Embodiment

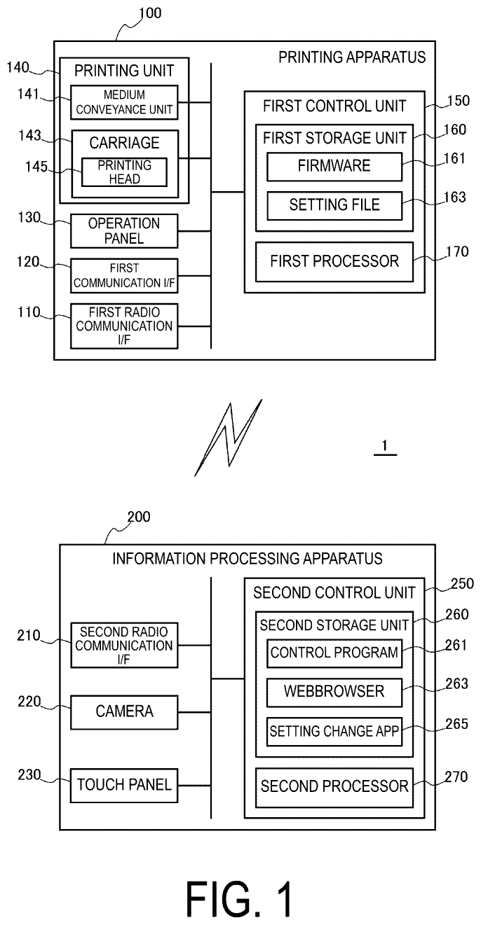

FIG. 1 is a diagram illustrating a system configuration of a printing system 1.

The printing system 1 includes a printing apparatus 100 and an information processing apparatus 200. The information processing apparatus 200 is coupled to the printing apparatus 100 in a wireless manner.

The printing apparatus 100 is an ink-jet printer. The printing apparatus 100 may be a thermal printer or an SIDM (Serial Impact Dot Matrix) printer. A SIDM printer generates dots by impacting the medium such as recording paper with a wire provided in a printing head through the ink ribbon.

The information processing apparatus 200 is a smartphone, or a tablet-type or note-type computer, for example.

### 2. Configuration of Printing Apparatus

The printing apparatus 100 includes a first radio communication interface 110, a first communication interface 120, an operation panel 130, a printing unit 140 and a first control unit 150. In the following description, the interface is abbreviated as I/F.

The first radio communication I/F 110 is a radio communication device including an antenna, an RF circuit, a baseband circuit, an encoder/decoder and the like. The first radio communication I/F 110 corresponds to the first radio communication unit.

The first radio communication I/F 110 executes P2P (Peer to Peer) communication with the information processing apparatus 200. This embodiment describes a case where the first radio communication I/F 110 executes P2P communication with the information processing apparatus 200 in accordance with Wi-Fi direct standard. In addition, the first radio communication I/F 110 operates in an infrastructure mode, and executes radio communication with the information processing apparatus 200 via a Wi-Fi access point not illustrated in the drawing. Wi-Fi is a registered trademark.

In addition, the first radio communication I/F 110 may be configured to execute short-range wireless communication using Bluetooth, NFC (Near Field Communication), Miracast and the like as P2P communication. Bluetooth is a registered trademark.

The first communication I/F 120 includes a communication module such as a LAN (Local Area Network) card. The first communication I/F 120 connects to a network not illustrated in the drawing and performs mutual data communication with apparatuses connected to the network. The first communication I/F 120 corresponds to the network communication unit.

The operation panel 130 receives user operations. The operation panel 130 includes a plurality of buttons such as a power button and an input button, for example.

The printing unit 140 includes a medium conveyance unit 141, a carriage 143 and a printing head 145.

The medium conveyance unit 141 conveys the medium in a predetermined conveyance direction under the control of the first control unit 150. The medium conveyance unit 141 includes a roller that rotates to convey the medium, a motor serving as a power source for the rotation and the like, for example. In this embodiment, roll paper is used as the medium.

The carriage 143, equipped with the printing head 145, moves back and forth in a main scanning direction with the power of a carriage motor not illustrated in the drawing.

The printing head 145 ejects ink to the medium to record the image under the control of the first control unit 150.

In this embodiment, the ink-jet printing apparatus 100 is described, but the printing apparatus 100 may be a thermal printer or an SIDM printer.

The first control unit 150 is a computer apparatus including a first storage unit 160 and a first processor 170.

The first storage unit 160 includes memories such as a RAM (Random Access Memory) and a ROM (Read Only Memory). The first storage unit 160 stores firmware 161 executed by the first processor 170, and a setting file 163. In addition, the first storage unit 160 is used also as a reception buffer for storing received printing data. The first storage unit 160 corresponds to the storage unit.

The setting file 163 is a file in which the setting of the printing apparatus 100 is registered. The setting of the printing apparatus 100 includes a password for determining whether to allow execution of the update processing described later, address information set to the printing apparatus 100 and the like, for example. This embodiment describes a case where the address information is an IP address. The setting file 163, a password and an IP address are registered as preset values.

The first processor 170 is an arithmetic processing apparatus composed of a CPU (Central Processing Unit) and/or an MPU (Micro Processor Unit). The first processor 170 may be composed of a single processor, or a plurality of processors. In addition, the first processor 170 may be configured to perform a process by a hardware circuit such as an ASIC, or configured such that a processor such as a CPU and an MPU and a hardware circuit perform a process in conjunction with each other.

### 3. Configuration of Information Processing Apparatus

The information processing apparatus 200 includes a second radio communication I/F 210, a camera 220, a touch panel 230 and a second control unit 250.

The second radio communication I/F 210 is a radio communication device including an antenna, an RF circuit, a baseband circuit, an encoder/decoder and the like. The second radio communication I/F 210 executes P2P communication with the printing apparatus 100. The second radio communication I/F 210 of this embodiment executes P2P communication with the printing apparatus 100 in accordance with Wi-Fi direct standard. In addition, the second radio communication I/F 210 operates in an infrastructure mode, and executes radio communication with the printing apparatus 100 via a Wi-Fi access point not illustrated in the drawing. The second radio communication I/F 210 corresponds to the second radio communication unit.

In addition, the second radio communication I/F 210 may be configured to execute short-range wireless communication using Bluetooth, NFC, Miracast and the like as P2P communication.

The camera 220 includes an imaging lens, an imaging element such as a CCD (Charge Coupled Device) and a CMOS (Complementary MOS), and a data processing circuit. Illustration of the imaging lens, imaging element and data processing circuit is omitted. The camera 220 executes imaging to generate a captured image under the instruction of the second control unit 250. The camera 220 corresponds to the reading unit.

The touch panel 230 includes a display panel such as a liquid crystal panel and an organic EL (Electro Luminescence) panel, and a touch sensor overlaid on the display panel. Illustration of the display panel and touch sensor is omitted.

The touch sensor detects a touch operation at a contact position of a user's finger on the touch panel 230. The touch sensor outputs to the second control unit 250 an operation signal including coordinate information representing the detected position of the touch operation. In addition, the touch panel 230 may include a hardware button. The touch panel 230 corresponds to the display device. In this embodiment, the information processing apparatus 200 includes the touch panel 230 as a display device, but the information processing apparatus 200 may be externally coupled to a display and the like such that the information processing apparatus 200 displays images on the display.

The second control unit 250 is a computer apparatus including a second storage unit 260 and a second processor 270.

The second storage unit 260 includes a memory such as a RAM and a ROM. The second storage unit 260 stores a control program 261 such as an OS (Operating System) executed by the second processor 270. In addition, the second storage unit 260 stores a setting change application program and a Webbrowser 263 as an application program. In the following description, an application program is referred to also as APP.

A setting change APP 265 is an application program that is executed on the Webbrowser 263, and has a function of changing the setting of the connected printing apparatus 100.

The second processor 270 is an arithmetic processing apparatus composed of a CPU and/or an MPU. The second processor 270 may be composed of a single processor, or a plurality of processors. In addition, the second processor 270 may be configured to perform a process by a hardware circuit such as an ASIC, or configured such that a processor such as a CPU and an MPU and a hardware circuit perform a process in conjunction with each other.

### 4. Operation of Printing System

When the printing apparatus 100 is activated with the first radio communication I/F 110 set to enable Wi-Fi direct, the first control unit 150 is connected to the information processing apparatus 200 through Wi-Fi direct communication.

Next, the first control unit 150 determines whether a printing condition set in advance is met. The printing condition set in advance includes the following five conditions. The printing conditions are printing conditions of a special code including the IP address described later.

1. No radio communication setting is configured.

2. No USB device is coupled to the printing apparatus 100.

3. No Ethernet cable is coupled to the printing apparatus 100.

4. No IP address for network communication is set.

5. Wi-Fi is enabled.

When the above-mentioned five conditions are met, the first control unit 150 prints the special code. When the above-mentioned five conditions are not met, the first control unit 150 does not print the special code.

The special code includes the address information of the printing apparatus 100. The address information is address information of network communication, and is an IP address, for example. In addition, the special code may be a one-dimensional code such as a bar code or a two-dimensional code such as a QR code. In this embodiment, a QR code is used as a special code. In addition, in this embodiment, the special code includes an IP address, but the special code may include an IP address and a password. QR code is a registered trademark.

The user reads a medium on which a QR code is printed with the camera 220. The image captured with the camera 220 is input to the second control unit 250. The second control unit 250 analyzes the input captured image, and acquires information included in the QR code. As described above, the QR code includes the IP address of the printing apparatus 100.

When acquiring the IP address included in the QR code, the second control unit 250 activates the Webbrowser 263, and inputs the acquired IP address of the printing apparatus 100 to the URL of the activated Webbrowser 263 to activate the setting change APP 265.

The second control unit 250 that executes the setting change APP 265 connects to the printing apparatus 100 corresponding to the input IP address, and causes it to display a password input screen under the control of the setting change APP 265. When a password is input to the password input screen, the second control unit 250 sends the input password to the printing apparatus 100. The printing apparatus 100 performs password authentication by determining whether the password received from the information processing apparatus 200 matches the registered password included in the setting file 163.

When the received password matches the registered password, the first control unit 150 sends an authentication completion notification to the information processing apparatus 200.

When receiving the authentication completion notification from the printing apparatus 100, the second control unit 250 displays an APP screen 300 to receive the setting change of the printing apparatus 100.

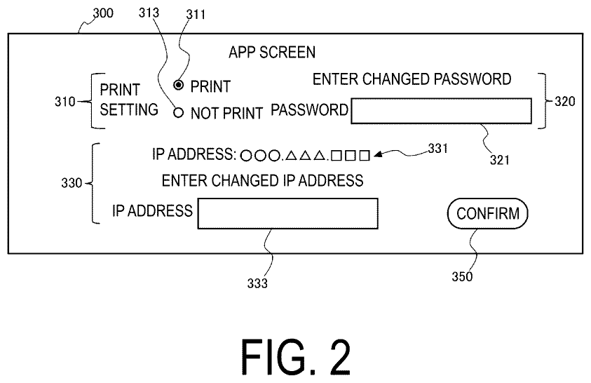

FIG. 2 is a diagram illustrating an example of the APP screen 300. The APP screen 300 is an example of the operation screen. The APP screen 300 includes a first setting column 310, a second setting column 320, a third setting column 330 and a confirm button 350.

The first setting column 310 is a setting column for setting whether to print the password. Specifically, it is a is a setting column for setting whether to print the changed password when the password is changed. The first setting column 310 includes a first radio button 311 and a second radio button 313. The first radio button 311 is a button to be selected to print the password. The second radio button 313 is a button to be selected to not print the password. After changing the password, the user selects the first radio button 311 through touch operation if the password is to be printed, or selects the second radio button 313 through touch operation if the password is not to be printed.

The second setting column 320 is a password setting column. The second setting column 320 includes an entry field 321. If the password is to be changed, the user enters the password to be changed into the entry field 321.

The third setting column 330 is an IP address setting column. The third setting column 330 includes a display column 331 and an entry field 333. In the display column 331, the current IP address of the printing apparatus 100 is displayed. The entry field 333 allows the user to enter the changed IP address of the printing apparatus 100. When changing the IP address, the user enters the changed IP address into the entry field 333.

When the confirm button 350 is pressed, the second control unit 250 sends a request for changing the setting change of the printing apparatus 100 to the printing apparatus 100. This change request includes at least one of the password and the IP address received in the APP screen 300. In addition, when the setting of the first setting column 310 is “print”, the change request including a printing instruction. When the setting of the first setting column 310 is “no print”, the change request does not include a printing instruction.

When receiving a change request from the information processing apparatus 200 connected through Wi-Fi direct to execute the setting change APP, the first control unit 150 changes the setting change of the printing apparatus 100. The first control unit 150 updates the setting of the printing apparatus 100 by rewriting the setting file 163 with at least one of the received password and the IP address.

Next, the first control unit 150 determines whether a printing instruction is included in the change request. When a printing instruction is included in the change request and the password and the IP address have been changed, the first control unit 150 causes the printing unit 140 to print the QR code including the IP address and the password.

When the password has been changed but the IP address has not been changed, the first control unit 150 causes the printing unit 140 to print the password. In addition, when the IP address has been changed but the password has not been changed, the first control unit 150 causes the printing unit 140 to print the QR code including the changed IP address.

In addition, when printing the password and/or the QR code including the IP address, the first control unit 150 may print the current date or the current date, and the time when the password and/or the IP address has been changed. Further, the first control unit 150 may print the model name of the printing apparatus 100.

The user can access the printing apparatus 100 by reading the QR code including the changed IP address with the camera 220 of the information processing apparatus 200. Specifically, the setting of the printing apparatus 100 can be changed by operating the APP screen 300 displayed on the touch panel 230. In addition, when the IP address has been changed, setting the IP address before the change in the URL of the Webbrowser 263 cannot access the printing apparatus 100.

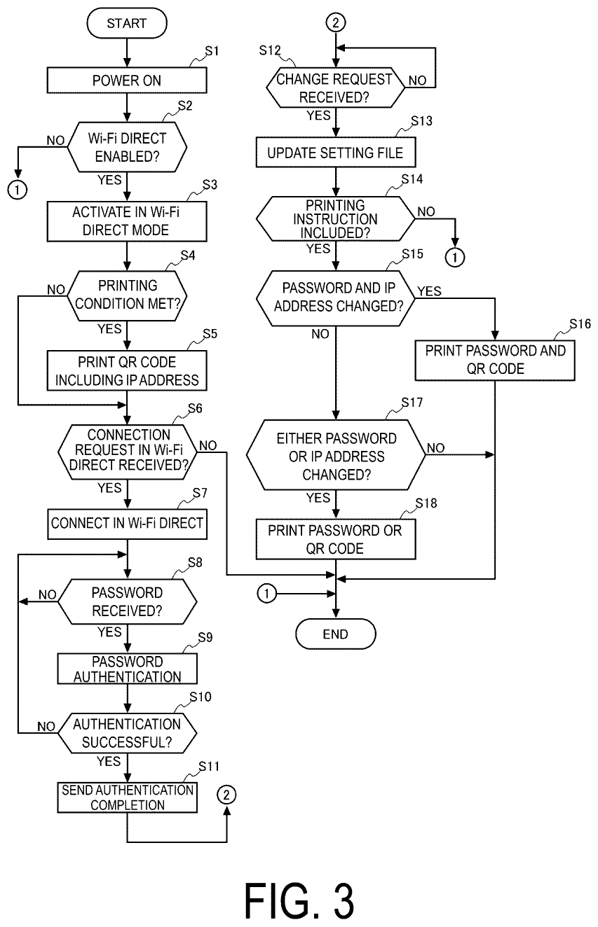

FIG. 3 is a flowchart illustrating an operation of the printing apparatus 100.

An operation of the printing apparatus 100 is described below with reference to the flowchart illustrated in FIG. 3.

When the power source of the printing apparatus 100 is turned on (step S1), the first control unit 150 determines whether the Wi-Fi direct setting is enabled (step S2).

When the Wi-Fi direct setting is disabled (step S2/NO), the first control unit 150 terminates this process flow and moves on to other processes.

When the Wi-Fi direct setting is enabled (step S2/YES), the first control unit 150 activates the first radio communication I/F 110 in a Wi-Fi direct mode (step S3).

Next, the first control unit 150 determines whether the printing condition set in advance is met (step S4). The printing condition set in advance is not met (step S4/NO), the first control unit 150 moves to the determination at step S6.

When the printing condition set in advance is met (step S4/YES), the first control unit 150 causes the printing unit 140 to print a QR code including the IP address of the printing apparatus 100 (step S5).

Next, the first control unit 150 determines whether a request for connection in Wi-Fi direct has been received (step S6). When a request for connection in Wi-Fi direct has not been received (step S6/NO), the first control unit 150 terminates this process flow and moves on to other processes.

When a request for connection in Wi-Fi direct has been received (step S6/YES), the first control unit 150 connects to the information processing apparatus 200 that has sent the connection request through Wi-Fi direct (step S7).

Next, the first control unit 150 determines whether a password has been received from the information processing apparatus 200 connected through Wi-Fi direct (step S8). When no password has been received (step S8/NO), the first control unit 150 waits until a password is received.

When receiving a password (step S8/YES), the first control unit 150 executes password authentication by determining whether the received password matches the registered password included in the setting file 163 (step S9). When the received password does not match the registered password, the first control unit 150 determines that the password authentication has failed (step S10/NO) and requests the information processing apparatus 200 to retransmit the password.

When the received password matches the registered password, the first control unit 150 determines that the password authentication has been successful (step S10/YES), and sends an authentication completion notification to the information processing apparatus 200 (step S11).

Next, the first control unit 150 determines whether a change request has been received (step S12). The change request includes at least one of a changed IP address and a password. In addition, when the setting of the first setting column 310 is “print”, the change request includes a printing instruction.

When no change request has been received (step S12/NO), the first control unit 150 waits until a change request is received. In addition, when the connection with the information processing apparatus 200 through Wi-Fi direct is disconnected and/or when a notification of the end of communication is received from the information processing apparatus 200, the first control unit 150 may release the waiting for reception of the change request to terminate this process flow.

In addition, when receiving a change request (step S12/YES), the first control unit 150 updates the setting file 163 on the basis of at least one of the IP address and the password included in the change request (step S13).

Next, the first control unit 150 determines whether a printing instruction is included in the change request (step S14). When no printing instruction is included in the change request (step S14/NO), the first control unit 150 terminates this process flow.

A printing instruction is included in the change request (step S14/YES), the first control unit 150 determines whether the password and the IP address have been changed in the update of setting file at step S13 (step S15). When the password and the IP address have been changed (step S15/YES), the first control unit 150 causes the printing unit 140 to print the QR code including the changed IP address and the password (step S16).

In addition, when the password and the IP address have not been changed in the update of setting file at step S13, (step S15/NO), the first control unit 150 determines whether one of the password and the IP address has been changed (step S17).

When one of the password and the IP address has been changed (step S17/YES), the first control unit 150 causes the printing unit 140 to print the QR code including the changed IP address or the changed password (step S18). In addition, when the password and the IP address have not been changed (step S17/NO), the first control unit 150 terminates this process flow.

Note that, in the above-described flowchart, when the received change request includes a printing instruction, the first control unit 150 prints the QR code including the IP address or the changed password. As another example, it is possible to adopt a configuration in which the change request that is sent from the second control unit 250 to the printing apparatus 100 does not include a printing instruction. In this case, the first control unit 150 determines whether the password or the IP address has been changed such that the password is printed when the password has been changed and that the QR code including the IP address is printed when the IP address has been changed.

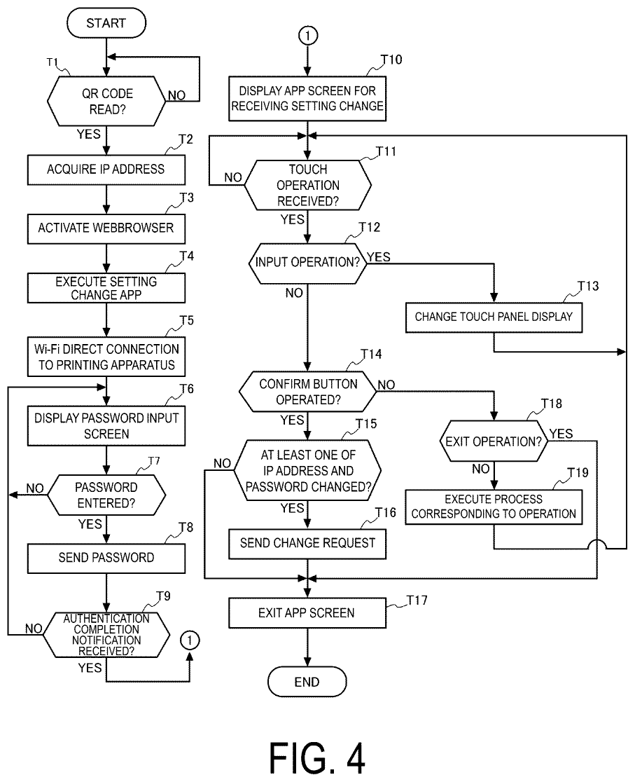

FIG. 4 is a flowchart illustrating an operation of the information processing apparatus 200.

An operation of the information processing apparatus 200 is described below with reference to the flowchart illustrated in FIG. 4.

The second control unit 250 determines whether the QR code has been read by activating the camera 220 (step T1). When no QR code has not been read (step T1/NO), the second control unit 250 waits until a QR code is read.

When a QR code is read by activating the camera 220 (step T1/YES), the second control unit 250 acquires the IP address included in the QR code by analyzing the captured image of the camera 220 (step T2).

Next, the second control unit 250 activates the Webbrowser 263 (step T3), and inputs the acquired IP address of the printing apparatus 100 to the URL of the activated Webbrowser 263 to execute the setting change APP 265 (step T4). The second control unit 250 that executes the setting change APP 265 connects to the printing apparatus 100 corresponding to the input IP address through Wi-Fi direct (step T5).

Next, the second control unit 250 executes the activated setting change APP 265 and displays a password input screen (step T6). When no password has been input (step T7/NO), the second control unit 250 waits until a password is input.

When a password is input in the input screen (step T7/YES), the second control unit 250 sends the input password to the printing apparatus 100 (step T8) and determines whether an authentication completion notification has been received (step T9). When no authentication completion notification has been received (step T9/NO) but a request for retransmission of the password has been received, the second control unit 250 determines that the authentication process has failed and requests reentry of the password (step T6).

When an authentication completion notification has been received (step T9/YES), the second control unit 250 causes the touch panel 230 to display the APP screen 300 for receiving the setting change of the printing apparatus 100 (step T10) and receives touch operation of the user (step T11). When no touch operation of the touch panel 230 has been received (step T11/NO), the second control unit 250 waits until a touch operation is received.

When a touch operation on the touch panel 230 has been received (step T11/YES), the second control unit 250 determines whether the received touch operation is an input operation of inputting an IP address and/or a password (step T12). When the received touch operation is an input operation (step T9/YES), the second control unit 250 changes the display of the touch panel 230 in accordance with the received touch operation (step T13) and returns to the determination of step T11.

In addition, when the received touch operation in not an input operation (step T12/NO), the second control unit 250 determines whether the received touch operation is an operation on the confirm button (step T14).

When the received touch operation is an operation on the confirm button (step T14/YES), the second control unit 250 determines whether at least one of the IP address and the password has been changed (step T15).

When at least one of the IP address and the password has been changed (step T15/YES), the second control unit 250 sends a change request to the printing apparatus 100 (step T16). This change request includes at least one of the changed password and IP address. In addition, the change request includes a printing instruction in the case where the setting of the first setting column 310 is “print”. When the second control unit 250 sends the change request to the printing apparatus 100, it terminates the display of the APP screen 300 displayed on the touch panel 230 (step T17) and displays other information. For example, the second control unit 250 displays information about the printing apparatus 100.

When the IP address and the password have not been changed (step T15/NO), the second control unit 250 terminates the display of the APP screen 300 (step T17) and displays other information. For example, the second control unit 250 displays information about the printing apparatus 100.

When the received touch operation is not an operation on the confirm button 350 (step T14/NO), the second control unit 250 determines whether the received touch operation is a termination operation (step T18). When the received touch operation is a termination operation (step T18/YES), the second control unit 250 terminates the display of the APP screen 300 (step T17) and displays other information. In addition, when the received touch operation is not a termination operation (step T18/NO), the second control unit 250 executes a process corresponding to the received operation (step T19) and returns to the determination of step T11.

### 5. Other Embodiments

The embodiments described above are preferred embodiments. However, the embodiments described above are not limitative, and various variations may be implemented within the scope that does not depart from the gist.

For example, each functional part illustrated in FIG. 1 indicates a functional configuration, and the specific implementation form is not limited. In other words, it is not necessary to implement hardware corresponding to each functional part individually, and it is of course possible to configure a single processor to realize the functions of multiple functional parts by executing a program. In addition, some of the functions realized in software in the above embodiments may be realized in hardware, or some of the functions realized in hardware may be realized in software.

The processing units in the flowcharts illustrated in FIGS. 3 and 4 are divided according to the main processing contents to facilitate understanding of the processing of the printing apparatus 100 and information processing apparatus 200, and the invention is not limited by the way the processing units are divided or their names. The processing of the printing apparatus 100 and information processing apparatus 200 may be further divided into many processing units according to the content of the processing. The processing of the printing apparatus 100 and the information processing apparatus 200 may be divided so that one processing unit includes even more processing.

When the method for changing the settings of the printing system is realized using a computer provided by the printing apparatus 100 and the information processing apparatus 200, the program to be executed by this computer can be configured in the form of a recording medium or a transmission medium for transmitting this program. As the recording medium, a magnetic or optical recording medium or a semiconductor memory device can be used. Specifically, portable or fixed recording media such as flexible disks, hard disk drives (HDDs), CD-ROMs, DVDs, Blu-ray Discs, optical magnetic disks, flash memory, and card-type recording media can be used. The above recording media can also be used in servers. The above recording media may also be non-volatile storage devices such as RAM, ROM, HDD, etc., which are internal storage devices provided by the server device. Blu-ray is a registered trademark.

### 6. Overview of the Present Disclosure

An overview of the present disclosure is described below.

### Supplementary Note 1

A printing system includes a printing apparatus, and an information processing apparatus, in which the printing apparatus includes a first radio communication unit configured to perform Peer-to-Peer communication, a network communication unit configured to perform network communication, a printing unit configured to print an image on a medium, a storage unit configured to store a setting of the printing apparatus, and a first control unit configured to cause the printing unit to print a special code including address information for the network communication when the first radio communication unit is in an enabled state and the printing apparatus is activated in a state where a condition set in advance is met, and the information processing apparatus includes a second radio communication unit configured to perform P2P communication, a reading unit configured to read the special code, and a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

According to this configuration, when the printing apparatus is activated in a state where a condition set in advance is met, the special code including the address information of the network communication is printed by the printing apparatus. In this manner, the special code that allows for an access to the printing apparatus is printed, and thus the information processing apparatus can access the printing apparatus with a simple operation, thereby improving user convenience.

In addition, when the operation screen for receiving a change to the setting of the printing apparatus is displayed and the setting of the printing apparatus is changed on the operation screen, the printing apparatus is instructed with the changed setting of the printing apparatus. In this manner, the setting of the printing apparatus can be changed.

### Supplementary Note 2

The printing system according to Supplementary Note 1, in which the setting of the printing apparatus includes a password, and when an operation of changing the password is received, the second control unit sends a changed password to the printing apparatus.

According to this configuration, when the password is changed by operating the operation screen, the changed password is sent to the printing apparatus. In this manner, the password of the printing apparatus can be changed.

### Supplementary Note 3

The printing system according to Supplementary Note 2, in which the second control unit sends, to the printing apparatus, the changed password and a printing instruction of the special code, and the first control unit causes the printing unit to print the special code with the printing instruction.

According to this configuration, when the password is changed by operating the operation screen, the changed password and the printing instruction of the special code are sent to the printing apparatus. In this manner, when the password of the printing apparatus is changed, the special code can be printed by the printing apparatus.

### Supplementary Note 4

The printing system according to Supplementary Note 2, in which the second control unit sends, to the printing apparatus, the changed password and a printing instruction of the password, and the first control unit causes the printing unit to print the password with the printing instruction.

According to this configuration, when the password is changed by operating the operation screen, the changed password and the printing instruction of the password are sent to the printing apparatus. In this manner, when the password of the printing apparatus is changed, the changed password can be printed by the printing apparatus.

### Supplementary Note 5

The printing system according to Supplementary Note 2, in which the second control unit erases a display of the operation screen after the changed password is sent to the printing apparatus.

According to this configuration, after the changed password is sent to the printing apparatus, the display of the operation screen is erased. This can set the state of not receiving the operation of changing the setting of the printing apparatus.

### Supplementary Note 6

The printing system according to Supplementary Note 1, in which the setting of the printing apparatus includes the address information, when an operation of changing the address information is received, the second control unit sends changed address information to the printing apparatus, and after the setting of the printing apparatus is changed based on the changed address information, the first control unit does not accept an access based on the special code including the address information before being changed.

According to this configuration, when the address information of the printing apparatus is changed on the operation screen, the changed address information is sent to the printing apparatus, and, after the setting of the address information is changed, the printing apparatus is set to a state of not receiving accesses based on the special code including the address information before the change. In this manner, accesses to the printing apparatus using the special code including the address information before the change can be prevented, thereby improving the safety.

### Supplementary Note 7

The printing system according to Supplementary Note 6, in which when the operation of changing the address information is received, the second control unit sends changed address information and a printing instruction of the address information to the printing apparatus, and the first control unit causes the printing unit to print the special code including the address information with the printing instruction.

According to this configuration, when the address information of the printing apparatus is changed on the operation screen, the changed address information and the printing instruction of the address information are sent to the printing apparatus. In this manner, the special code including the changed address information can be printed by the printing apparatus.

### Supplementary Note 8

The printing system according to Supplementary Note 7, in which the first control unit causes the printing unit to print the special code and a model name of the printing apparatus.

According to this configuration, the special code and the printing apparatus model name are printed by the printing apparatus. In this manner, the user convenience can be improved.

### Supplementary Note 9

The printing system according to Supplementary Note 7, in which the first control unit causes the printing unit to print the special code and a date.

According to this configuration, the special code and the date are printed by the printing apparatus. In this manner, the user convenience can be improved.

### Supplementary Note 10

The printing system according to Supplementary Note 7, in which the first control unit causes the printing unit to print the special code, a date and a time.

According to this configuration, the special code, the date and the time are printed by the printing apparatus. In this manner, the user convenience can be improved.

### Supplementary Note 11

The printing system according to Supplementary Note 1, in which the special code is a QR code that is a registered trademark.

According to this configuration, a QR code is used as the special code. In this manner, the amount of information included in the special code increases, thereby increasing the safety.

### Supplementary Note 12

The printing system according to Supplementary Note 7, in which the operation screen includes a setting item to enable or disable printing of the special code, and when a setting of the setting item is disabled, the second control unit does not send the printing instruction of the address information to the printing apparatus.

According to this configuration, the operation screen includes the setting items to enable or disable the printing of the special code, and when the setting item is disabled, the printing instruction of the address information is not sent to the printing apparatus. In this manner, the user can select whether to print the special code including the address information, thereby improving user convenience.

### Supplementary Note 13

A printing apparatus includes a first radio communication unit configured to perform Peer-to-Peer communication, a network communication unit configured to perform network communication, a printing unit configured to print an image on a medium, a storage unit configured to store a setting of the printing apparatus, and a first control unit configured to cause the printing unit to print a special code including address information for the network communication when the first radio communication unit is in an enabled state and the printing apparatus is activated in a state where a condition set in advance is met.

According to this configuration, when the printing apparatus is activated in a state where a condition set in advance is met, the special code including the address information of the network communication is printed by the printing apparatus. In this manner, the special code that allows for an access to the printing apparatus is printed, and thus the information processing apparatus can access the printing apparatus with a simple operation, thereby improving user convenience.

### Supplementary Note 14

An information processing apparatus includes a second radio communication unit configured to perform the P2P communication, a reading unit configured to read the special code, a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

According to this configuration, when the operation screen for receiving a change to the setting of the printing apparatus is displayed and the setting of the printing apparatus is changed on the operation screen, the printing apparatus is instructed with the changed setting of the printing apparatus. In this manner, the setting of the printing apparatus can be changed by reading the special code, thereby improving user convenience.

### Supplementary Note 15

A method of changing a setting of a printing system, the printing system including a printing apparatus and an information processing apparatus, the printing apparatus including a first radio communication unit configured to perform Peer-to-Peer communication, a network communication unit configured to perform network communication, and a printing unit configured to print an image on a medium, the information processing apparatus including a second radio communication unit configured to perform the P2P communication, and a reading unit, in which the printing apparatus causes the printing unit to print a special code including address information for the network communication when the first radio communication unit is in an enabled state and the printing apparatus is activated in a state where a condition set in advance is met, and the information processing apparatus accesses the printing apparatus based on the special code read by the reading unit, causes a display device to display an operation screen for receiving a change to the setting of the printing apparatus, and sends, to the printing apparatus, a changed setting of the printing apparatus when an operation of changing the setting of the printing apparatus is received.

According to this configuration, when the printing apparatus is activated in a state where a condition set in advance is met, the special code including the address information of the network communication is printed by the printing apparatus. In this manner, the special code that allows for an access to the printing apparatus is printed, and thus the information processing apparatus can access the printing apparatus with a simple operation, thereby improving user convenience.

In addition, when the operation screen for receiving a change to the setting of the printing apparatus is displayed and the setting of the printing apparatus is changed on the operation screen, the printing apparatus is instructed with the changed setting of the printing apparatus. In this manner, the setting of the printing apparatus can be changed.

What is claimed is:

1. A printing system comprising:
a printing apparatus; and
an information processing apparatus, wherein
the printing apparatus includes:
a first radio communication unit configured to perform Peer-to-Peer communication,
a network communication unit configured to perform network communication,
a printing unit configured to print an image on a medium,
a storage unit configured to store a setting of the printing apparatus, and
a first control unit configured to cause the printing unit to print a special code including address information for the network communication when the first radio communication unit is in an enabled state and the printing apparatus is activated in a state where a condition set in advance is met, and
the information processing apparatus includes:
a second radio communication unit configured to perform P2P communication,
a reading unit configured to read the special code, and
a second control unit configured to access the printing apparatus based on the special code read by the reading unit, cause a display device to display an operation screen for receiving a change to the setting of the printing apparatus, and instruct the printing apparatus to implement the changed setting of the printing apparatus when an operation of changing the setting of the printing apparatus is received.

2. The printing system according to claim 1, wherein
the setting of the printing apparatus includes a password, and
when an operation of changing the password is received, the second control unit sends a changed password to the printing apparatus.

3. The printing system according to claim 2, wherein
the second control unit sends, to the printing apparatus, the changed password and a printing instruction of the special code, and
the first control unit causes the printing unit to print the special code with the printing instruction.

4. The printing system according to claim 2, wherein
the second control unit sends, to the printing apparatus, the changed password and a printing instruction of the password, and
the first control unit causes the printing unit to print the password with the printing instruction.

5. The printing system according to claim 2, wherein the second control unit erases a display of the operation screen after the changed password is sent to the printing apparatus.

6. The printing system according to claim 1, wherein
the setting of the printing apparatus includes the address information,
when an operation of changing the address information is received, the second control unit sends changed address information to the printing apparatus, and
after the setting of the printing apparatus is changed based on the changed address information, the first control unit does not accept an access based on the special code including the address information before being changed.

7. The printing system according to claim 6, wherein
when the operation of changing the address information is received, the second control unit sends changed address information and a printing instruction of the address information to the printing apparatus, and
the first control unit causes the printing unit to print the special code including the address information with the printing instruction.

8. The printing system according to claim 7, wherein the first control unit causes the printing unit to print the special code and a model name of the printing apparatus.

9. The printing system according to claim 7, wherein the first control unit causes the printing unit to print the special code and a date.

10. The printing system according to claim 7, wherein the first control unit causes the printing unit to print the special code, a date and a time.

11. The printing system according to claim 1, wherein the special code is a QR code that is a registered trademark.

12. The printing system according to claim 7, wherein
the operation screen includes a setting item to enable or disable printing of the special code, and
when a setting of the setting item is disabled, the second control unit does not send the printing instruction of the address information to the printing apparatus.

13. A printing apparatus comprising:
a first radio communication unit configured to perform Peer-to-Peer communication;
a network communication unit configured to perform network communication;
a printing unit configured to print an image on a medium,
a storage unit configured to store a setting of the printing apparatus; and
a first control unit configured to cause the printing unit to print a special code including address information for the network communication when the first radio communication unit is in an enabled state and the printing apparatus is activated in a state where a condition set in advance is met.

14. A method of changing a setting of a printing system, the printing system including a printing apparatus and an information processing apparatus, the printing apparatus including a first radio communication unit configured to perform Peer-to-Peer communication, a network communication unit configured to perform network communication, and a printing unit configured to print an image on a medium, the information processing apparatus including a second radio communication unit configured to perform the P2P communication, and a reading unit, wherein
the printing apparatus causes the printing unit to print a special code including address information for the network communication when the first radio communication unit is in an enabled state and the printing apparatus is activated in a state where a condition set in advance is met, and
the information processing apparatus accesses the printing apparatus based on the special code read by the reading unit, causes a display device to display an operation screen for receiving a change to the setting of the printing apparatus, and sends, to the printing apparatus, a changed setting of the printing apparatus when an operation of changing the setting of the printing apparatus is received.
